(19) United States
(12) Patent Application Publication
(10) Pub. No.: US 2004/0054574 A1
(43) Pub. Date: Mar. 18, 2004

(54) System and method for the targeted distribution of promotional information over a network

(76) Inventors: Arthur H. Kaufman, Boca Raton, FL (US); Paul R. Hoffman, New York, NY (US)

Correspondence Address: Arthur H. Kaufman, 8171 Nadmar Avenue, Boca Raton, FL, 33434, US

(21) Appl. No.: 10/242,420

(22) Filed: Sep. 13, 2002

(51) Int. Cl. G06F 17/60

(52) U.S. Cl. 705/14

(57) ABSTRACT

A system for distributing dated promotions over the internet via email to registered consumers permits the consumer to identify goods of interest and offers numerous ways to limit or restrict the number of dated promotions to be received in a given time period, such as by relative importance of goods, level of retail outlet, intended user, and the like, so that received dated promotions are of the most significance to the consumer.

### FIELD OF THE INVENTION

The present invention relates to a data processing system and method for the generation and targeted distribution of dated promotions, discount coupons, and other promotional material over a network and, more particularly, to an integrated system and method for generating dated promotions on a server based on instructions received by a plurality of retailers, for distributing the dated promotions to consumers via email for redemption within time-limited periods (e.g., summer sales, winter sales, private one-day sales, three-day sales, and the like) or on dates associated with significant purchasing activities such as birthdays, anniversaries, holidays (e.g., president's birthdays, Christmas sales, Easter sales, and the like), and for monitoring the distribution and redemption of such dated promotions.

### BACKGROUND OF THE INVENTION

Purchase incentives such as dated promotions (one-day sales, holiday sales, private sales, and the like), and other types of purchase incentives (e.g., discount coupons), have long been distributed to consumers to promote the sale of goods or services. Typically, advertisers issue printed coupons which can be redeemed at a local retail outlet (or by mail) for a discount or refund upon making a purchase of goods identified by the coupon. Such coupons and promotions are commonly distributed by mail or printed in periodicals or newspapers. This method of promotion has proven to be only marginally effective, requiring the distribution of coupons to hundreds or even thousands of consumers to generate only a single sale. Thus, the conventional methods of coupon and dated promotion distribution have caused problems for manufacturers, consumers and merchants due to their massive inefficiency.

For instance, in order to obtain a small number of relevant discount coupons, a consumer is normally required to search for and clip such coupons from a plurality of publications or mailings containing many other irrelevant and unwanted coupons. The consumer must thus clip, categorize, sort and store in an organized manner the relevant coupons for use upon his or her next visit to a retail outlet, such as a grocery store. This conventional method of coupon distribution has a disadvantage in that many consumers simply lack the time or initiative to search for and clip coupons. Thus, printed coupons issued by manufacturers and retailers generally reach only a small segment of the consuming public, i.e., those who clip coupons based upon personal interest or financial necessity. Although manufacturers may wish to reach a larger percentage of consumers having the greatest spending power, many such consumers do not clip coupons due to the inordinate amount of time required to do so.

The explosive growth of the internet as a means of electronic consumer-based commerce has made the Internet a suitable medium for the targeted distribution of promotional information such as dated promotions to consumers. Consumers are increasingly accessing online resources to conduct purchasing transactions over the World Wide Web. Online advertising and the promotion of goods and services online are among the most popular commercial applications of the Internet, and the Internet has become an extremely significant advertising tool.

In addition, the growth trend experienced by the Internet is likely to be equaled or exceeded by a similar trend in the television industry (i.e., so-called interactive TV), the handheld computer industry, and the wireless communication industry, all of which are generally well-suited for the targeted distribution of discount coupons and other purchase incentives.

However, conventional Web-based advertising tools are not particularly well-suited for the distribution of dated promotions. Dated promotions, as used herein, means time-sensitive offers such as notices of one-day sales, holiday sales, special events, and the like, which are intended to notify interested consumers of an upcoming sales event open to the general public, or a limited segment of the public, or preferred consumers only. Statistics have shown that when interested consumers are sent information on a specific date giving them abbreviated notice, such as one, two or three days notice, of an upcoming sale or event, such as a private sale, a private one-day (or multiple-day) sale, a holiday sale, or the like, consumer response greatly exceeds any other type of promotion. Typically, dated promotions are issued shortly before the upcoming sales event and thus require immediate attention by the consumer. Conventional web-based advertising methods are not capable of distinguishing interested consumers from those who are disinterested and are not capable of generating a higher percentage of interest in a product or sale than conventional Internet-based coupon distribution services. Thus, conventional Internet promotional applications are not geared to satisfy this need.

Accordingly, conventional web-based advertising methods do not provide for adequate targeting of promotional materials and are not particularly well suited for the distribution of dated promotions and are no more well-suited for the distribution of discount coupons than conventional print media. In addition to the inability to distribute such promotions on a sufficiently targeted basis, current Web-based techniques make it difficult for individual companies to obtain meaningful data concerning the demand for their products. Although Web site administrators can monitor consumer use and interaction with their own Web sites and ad banners, no current means provides for the accurate monitoring of consumer purchasing habits on a widespread basis independent of computer use or Internet access. The monitoring of Web site and ad banner access does not necessarily equate with consumer interests or purchasing habits. While the value and effectiveness of such resources can be accurately monitored by known monitoring techniques, such techniques do not provide for the adequate targeting of purchase incentives. As a result, much of the promotional information provided by a server over a public network is untargeted. To the extent that promotional information is served on a targeted basis, such targeting is not necessarily beneficial since it is not done in response to consumer interests or requests nor is it based on actual purchasing decisions.

Due to the inconvenience of conventional promotional information distribution methods and the limited monitoring abilities of conventional distribution systems, it has been difficult to build customer loyalty or to attract new customers through the use of targeted and dated purchase incentives. Only with knowledge of a consumer's biographical data, such as address, date of birth, anniversary, preferences, timing and quantity of purchases, and other relevant purchasing information, can such targeting be achieved on an adequate basis. While this valuable information is available to credit card issuers, it is particularly difficult for local retailers to obtain and utilize such information. Thus, while information such as address, date of birth and anniversary of residents in the vicinity of their businesses would offer valuable marketing opportunities to local retailers and service providers such as restaurants and boutiques, such information has only been exploited to a small degree, and has not been utilized in connection with Web-based coupon distribution services.

Due largely to the inability of current distribution services to adequately target dated promotions and discount coupons to interested consumers, use of the Internet for the dissemination of promotional material has essentially resulted in an increased amount of unsolicited junk mail. In other words, the same or similar packages of mostly useless discount coupons and promotional literature received by consumers by regular mail are being served to the same consumers via Internet resources, such as email facilities, with the same inefficiency.

In view of the foregoing, there is currently a need for a data processing system and method for the targeted distribution of dated promotions over a network which provides offerers of goods and services with the ability to generate and distribute dated promotions to interested consumers in a selected geographical locale based on demographic and biographical data associated with such consumers, such as address, date of birth, anniversaries, and the like. Such dated promotions may be issued, for example, one or two days prior to an actual event to give notice of an event lasting no more than, for example, three days. For instance, by using a central server to distribute dated promotions offered by local businesses to residents in the vicinity of the businesses which are redeemable on target date ranges or on dates known to be associated with substantial purchasing activities, such a system would offer the ability to exploit a thus far untapped market. There is also a need for the ability to monitor the effectiveness of such dated promotions as well as a need to provide individual consumers with the ability to easily obtain dated promotions and other purchase incentives which are tailored to their individual biographical data and to avoid the automatic transmission of large numbers of irrelevant, unsolicited and unwanted discount coupons. Current online methods used for the distribution of promotional information are not capable of adequately targeting offers and merely serve the same information to all users.

Furthermore, current techniques used for the distribution of promotional information by email have resulted in widespread nuisance. “Spamming”, as it is commonly known, involves the widespread distribution of promotional material by email to a large number of disinterested consumers. This nuisance has attracted substantial regulatory and legislative activity and has prompted Internet service providers to filter such emails. In view of the problems associated with the distribution of large numbers of unsolicited promotional emails received by consumers, there is also a need for a system of the foregoing type that is capable of targeting dated promotions to interested consumers and limiting the number of dated promotions sent to consumers via email in a manner that allows consumers to limit the number of emails by manual selection and also allows consumers to prioritize the promotions that are to be emailed to the consumer so that the most important or pertinent promotions are sent to the consumer with greater preference than promotions of lesser importance.

Another need exists in the field to create additional incentives that are effective to attract consumers to retail outlets. It is widely accepted that “half the battle” associated with retail sales is attracting local consumers into retail outlets. Once there, the marketing goods or services is done by fancy displays and charismatic salespersons. There is thus a current need for a mechanism useful in attracting consumers to retail outlets using the theme of additional incentives such as a sweepstakes type prize.

### SUMMARY OF THE INVENTION

In view of the foregoing, an object of the present invention is to provide an integrated data processing system and method which provides for the creation and distribution of promotional information including dated promotions (and other promotional items) using electronic means on a targeted basis over a network, such as a computer network (e.g., the Internet or World Wide Web), a television network (e.g., interactive TV), a telephone network, a wireless network (cellular, wireless web, satellite), and the like.

Another object of the present invention is to provide a data processing system and method by which consumers are provided with time-limited dated promotions, preferably those of the type notifying a consumer of an impending sale occurring within one or two days and lasting only one-, two- or three-days, or the like, and other promotional material, over a network which may provide notice of an upcoming sale or event, or which may be redeemed at a retail outlet to obtain goods or services within a certain range of dates, or on specific dates such as birthdays, anniversaries, holidays, and the like. Once downloaded to a consumer's data processing unit, the dated promotions provide the consumer with all required information about a sale or other event, such as the identity of the retailer or service provider, the time and date of the sale, the amount of the sale, and the goods or services on sale. The dated promotion is preferably transmitted to the consumer by email or like facility after a registration process has been completed and can be displayed or take the form of a printed document which may or may not require redemption at the retail outlet, and which may optionally be electronically stored in the memory of the user's general computing device or electronic mail facility for later reference.

Still another object of the present invention is to provide a data processing system and method which enables retailers and other providers of goods or services to target the distribution of dated promotions and other purchase incentives to consumers who reside in the immediate vicinity of the retailer and/or intend to purchase goods within a specific category. This may be achieved by transmitting to the consumer over the Internet a registration fill-in form, or by making a hardcopy of such a form available in retail outlets or the like, requesting the consumer to provide demographic data, such as name, residence address, email address, and preferences of goods. Only the consumer's geographic area and email address are essential. Other information may also be requested, if desired, such as budget, preferred user of goods, range of the consumer's age, interests, and the like, in order to enable the inventive system to make an educated determination of the nature of dated promotions to be transmitted via email to consumers and avoid the distribution of unwanted and unwelcome promotional emails. The dated promotions are transmitted to the consumer via email in a separate files each preferably containing only a single dated promotion along with a header for display on the user's email facility identifying the nature of the sale, so that the consumer need not actually open the email to learn the specifics of the promotion. Importantly, the dated promotions are selected from those retailers and/or service providers located in the geographic vicinity (such as a comfortable walking or driving distance) of the residence of the consumer, which information is determined based on the consumer's residence address entered in the registration form. In another aspect, the consumer contacts the server using a computing device (e.g., computer, cellular phone, or the like) and notifies the system of a zip code or other geographic indicator so that the consumer may receive dated promotions pertinent to that geographic area. This extends the consumer's ability to obtain promotions while traveling. The required information to be provided to the server can be determined based on zip code, telephone area code, telephone dialing exchange, or the like. During the registration process, consumers are preferably provided with a list of goods and services for which the consumer is interested in receiving dated promotions and other information as described hereinbelow, and are optionally asked to prioritize the importance of various goods and for any limit on the number of emails to be received in a given time period.

As noted above, dated promotions transmitted via email are preferably arranged so that each promotion offered by a retailer is given its own email transmission and heading so that the consumer may determine from the heading alone the identity of the nature of the dated promotion, such as the type of goods, the identity of the retailer offering the promotion, the date(s) of the dale and/or the amount of the savings.

By distributing dated promotions in the foregoing manner, such promotions are distributed to consumers who actually have an interest in the goods offered for sale, and provide for notice of special, highly time-sensitive sales of the type described above, or the like, during certain ranges of dates or on specific dates associated with substantial purchasing activity.

In another aspect of the invention, in order to limit the number of emails containing dated promotions (or other promotional items) that a consumer will receive, the invention preferably provides the consumer during the registration process (or thereafter) with the ability to restrict the number of promotional emails in one or more ways. For instance, the consumer may be given the option of selecting the maximum number of emails containing dated promotions that he or she wishes to receive in a given time period, and/or the ability to prioritize by order of importance among the list of goods or services contained in the registration form. When a maximum number of emails per unit time period (e.g., one day, one week, or the like) has been transmitted to the user, no further emails are sent during that time period. In that case, the user may be notified that additional promotions are available and may be received by clicking on a given link in another email.

In accordance with the foregoing aspect of the invention, the consumer is given the opportunity to limit or restrict the number of promotions received via email or similar facility. This may be facilitated by means of a hardcopy registration form or online in the foregoing manner. During the registration process, whether online or otherwise, or during a period of connection with a server over a communications medium (e.g., the internet), the consumer is provided with options for achieving the desired level of restriction. If performed online, a server downloads a file to the consumer unit which displays on the consumer unit one or more options for restricting or limiting the number of dated promotions to be transmitted to the consumer unit over a given period of time, for instance. These options may alternatively or additional be included in a hardcopy form as described above. These options may include an option allowing the consumer to specify an absolute maximum number of dated promotions that may be transmitted to the consumer at a given email address during a given time period (e.g., one day, week or month). Alternatively, or in addition thereto, the consumer may be given an option to prioritize the dated promotions that will be emailed, such as by allowing the consumer to prioritize in order of importance among the items of goods or services contained in the registration form. Thus, if a maximum number of emails has been entered, emails containing dated promotions from the most important categories will be transmitted with highest priority. The desired level of restriction may also be accomplished by allowing the consumer to limit the transmission of dated promotions to one or more specific days such as one or more specific dates, specific holidays (or all holidays), birthdays, anniversaries, or the like, or to limit the dated promotions to specific types of promotions (e.g., holiday sales, one-day sales, private sales, 50% or more sales). Other ways such promotions may be limited is by allowing the consumer to prioritize dated promotions by type of goods, intended user or consumer (children, women, men, etc.), or level of retail outlet (e.g., upper tier, middle tier, lower tier). By permitting the consumer to restrict or prioritize among levels of retail outlets, the consumer is given the ability to specify budgetary concerns. Thus, for instance, if a consumer has no intention of shopping in a high level boutique absent a significant sale in such retail outlet, such retailers can be omitted entirely or given lower priority in the absence of such a sale by means of the present invention. Thus, the moment the consumers sees that he or she has received an email from that retail outlet, he or she will be aware of an imminent significant sale or other offer. Yet another way consumers may limit the number of dated promotions to be transmitted is by restricting the receipt of dated promotions to those offered by retailers within a specific town, village, or geographic distance from the consumer's home.

Furthermore, any one or more of the foregoing means of limiting the number of dated promotions may be used alone or in combination. For instance, by allowing the consumer to restrict the maximum number of dated promotions to be received in a given time period and to prioritize among the various dated promotions in terms of importance of goods on a given scale (or other prioritizing scheme discussed above), the number of dated promotions that will be received by the consumer will be limited to those which are of the greatest significance to the consumer and hence the most likely to be utilized, thereby enhancing the value of the inventive system and method.

After registration has been completed, a server is used to transmit via email (or like facility) dated promotions as defined above (and optionally other promotional items) for particular goods or services offered by retailers in the geographic vicinity of the consumer. The server transmits to the consumer's data processing unit the dated promotions in email form each preferably in a separate email having its own header with a list of retail outlets in their geographic vicinity. The server accepts a selection from the displayed list of retail outlets by a consumer.

In an optional aspect of the invention, the server may also transmit for display on the consumer's data processing unit a list of retail outlets in the consumer's geographic vicinity, each being individually selectable, and, upon selection of a retailer, transmits a file containing a list of goods offered for sale at the selected retail outlet(s) at a discount. Using the displayed file contents, the consumer may select one or more item of goods and/or services using the user input device. The selection of goods and/or services by the consumer is transmitted to the server over the communication medium, whereupon the server searches its memory for dated promotions, coupons, or other promotional information or offers pertaining to such goods or services. Any such promotional items are then transmitted to the consumer data processing unit for outputting in printed or electronic form on an attached hardcopy apparatus, for permanent or temporary storage in the memory thereof, and/or for retaining in the consumer's email storage facility.

Another object of the present invention is to provide a data processing system and method for creating a database of user profiles which can be used to identify individual consumers as well as consumer purchasing habits, including information such as birth date, brand preferences, priority options selected as described above, timing and quantity of purchases, and the like, and information concerning promotions that have been viewed, downloaded, printed and/or redeemed by individual consumers. This information may be used to analyze the demand for particular products and brands on a demographic basis or the effectiveness of associated promotional campaigns, and, importantly, for the targeted distribution of promotional information to individual consumers.

Still another object of the present invention to provide means for assembling resources containing promotional information for service to consumers, such as dated promotions, discount coupons or other promotional incentives, Web pages or other graphical or textual media containing discount coupons, targeted advertisements, or other promotional information, in accordance with a historic user profile containing information relevant to the purchasing habits of individual consumers so that highly targeted promotional information and purchasing incentives can be provided.

In order to achieve the above-described and other objects and advantages, the present invention provides an integrated data processing system and method for the generation and distribution and dated promotions and other promotional information on a network which provides for the creation of promotions by issuers, such as manufacturers and retailers of goods and services, the distribution of such promotions to interested consumers on a targeted basis in accordance with residence (or work) address (or any desired geographic area, such as if the consumer is visiting a location away from home or work), and optionally with purchasing decisions, and the monitoring of one or more of the downloading, printing and redemption of such promotions, and to produce and maintain a database of consumer profiles for marketing purposes.

The invention broadly comprises an electronic promotional information distribution system and method, the system comprising one or more consumer data processing units operated by a consumer, each comprising a display, a memory for storing data to be displayed, a data processing unit having communication means connectable over a communication medium to at least a server, and a user input device to permit a consumer to make one or more selections from choices displayed on the display monitor. A server is located remotely from the consumer data processing units and comprises a memory for storing consumer demographic data, promotional information such as dated promotions issued by a plurality of vendors, and optionally a list of goods and services offered for sale by the vendors, and data used for generating electronic dated promotions for the vendors and optionally for specific goods and services offered by the vendors, a processing unit having communication means selectively connectable over the communication medium to the at least one consumer data processing unit, and being responsive to a connection with a consumer data processing unit to transmit for display on the consumer data processing unit a file containing promotional information such as dated promotions of one or more retailers in the geographic vicinity (such as a comfortable walking or driving distance) of the residence of the consumer, and providing a registration process by providing the user with a registration fill-in form through which consumers are given the identity of the list of goods and services offered for sale at discount prices by the one or more retailers, the listed goods being individually selectable by the consumer, and the server being responsive to the selection of one or more items of goods by the consumer to transmit via email or like means a file to the consumer data processing unit containing one or more dated promotions corresponding to one or more of the selected goods offered by retailers in the geographic vicinity of the consumer's residence. The registration form transmitted by the server (or provided in hardcopy form in any location) also allows the consumer to restrict the number of dated promotions to be transmitted to the consumer data processing unit by allowing the consumer to specify at least one of a maximum number of dated promotions to be received during a given time period, the relative level of importance of each of the selected goods or services, the relative importance among the various tiers of retail outlets, geographic restrictions such as town, village, etc., and the like, of retailers from which dated promotions are desired.

Dated promotions transmitted via email are preferably arranged so that each promotion offered by a retailer is given its own email transmission and attention-grabbing heading so that the consumer may determine from the heading alone the identity of the retailer offering the promotion and the nature of the promotion (e.g., the type of sale, or giveaway) and, if applicable, the type of goods/services to which the promotion applies.

In one embodiment, the consumer data processing units comprise client computers and the server comprises a server on a client/server network. The server is preferably an Internet host computer.

In another embodiment of the invention, in addition to storing dated promotions to promote events such as one-day sales and the like made available by the retailers, the server memory preferably stores retail outlet data for storing a list of goods sold by various types of retail outlets for transmitting for display on the consumer data processing unit a list of goods typically sold at specific type of retail outlet, such as a grocery store, a department store, and the like. The memory of the server further includes retail outlet data for identifying a plurality of retail outlets by type, name and inventory of goods. In that case, the data processing unit of the server may further comprise means responsive to a connection with a consumer data processing unit to transmit for display on the consumer data processing unit a file containing a list of participating retail outlets which are offering discounts to the consumer on the dates of interest which may be individually selected by the consumer using the user input device, the data processing unit of the server being further responsive to the selection made by a consumer to transmit for display on the consumer data processing unit a tile containing retail outlet data including the list of goods and services offered by retailers and associated coupon data. In that case, electronic dated promotions or other promotions downloaded to the consumer data processing unit would be selected from the list of goods and services sold at the selected retail outlets.

The data processing unit of the server may also include means for acquiring consumer identifying indicia, such as demographic data identifying the consumer, which may be processed by the data processing unit of the server to select one or more participating retail outlets in the geographical vicinity of the consumer so that the server can transmit to the consumer unit dated promotions based on the above-described criteria.

In another embodiment, the server can download to the consumer data processing unit a file containing a list of participating retail outlets within the geographic vicinity of the consumer.

As noted above, the means for acquiring consumer identifying indicia may comprise means for transmitting a registration file to the consumer unit containing a fill-in form requesting the consumer's address, zip code, telephone number, or other indicia from which the geographic location of the consumer may be determined. Alternatively, such information can be obtained through hardcopies of registration forms made available in retail outlets, point-of-sale displays, print media, and which are filled out by interested consumers and manually entered into the server. Additional information may be requested to facilitate the construction of a database of consumer profiles useful for marketing purposes. Demographic data, including name, residence and email addresses, date of birth, brand and goods/services preferences, and the like, may also be obtained in other ways, such as through Internet service providers and credit card issuers.

To transmit dated promotions to the consumer, the server must first execute a registration process by which it identifies a consumer (or consumer data processing unit), and determines consumer identifying data, including the geographic location of the consumer data processing unit (e.g., the residence address of the consumer) and optionally other demographic data, including date of birth, anniversary, and the like, of the consumer, along with the goods and/or services selected by the consumer and any information pertaining to restrictions entered by the consumer.

The server may execute a registration process during a connection established between the consumer data processing unit and the server or by a hardcopy registration form. In either case, the information including identifying indicia and goods or services of interest from the consumer are sought. The server also optionally determines previous transactions made by the consumer data processing unit so that promotions such as purchase incentives and other information may be served on a targeted basis based with reference to a file containing the consumer's prior transactions.

Once registration has been completed, consumers are provided with dated promotions of the type described above. Consumers are notified by email of time-sensitive sales and special events offered by retailers in their geographic vicinity. Retailers and other offerors of goods and services can transmit to the server information pertaining to upcoming sales (such as private time-limited sales) and events so that the server may notify consumers within the geographic region of the retailers via email of the sales and events.

According to the invention as described above, the consumer is able to obtain dated promotions for a geographical area corresponding to his or her residence address, work address, or any other desired area. Thus, in accordance with any of the foregoing aspects of the invention, a consumer who resides in a given area and who normally receives dated promotions from retailers in that area (and optionally from his or her work area), may also obtain dated promotions for any other area. In such an embodiment, the consumer informs the server when he or she is traveling to another area by notifying the server of the area the consumer is traveling to and the date and/or time that the consumer will be in the other area. The server downloads to the consumer dated promotions from such area. The dated promotions may be in the form of emails as, described above. However, when the consumer is traveling and has no access to a computer, the dated promotions may be in the form of text messages on a beeper or cellular telephone. This embodiment is equally applicable to provide consumers with dated promotions offered by retailers (such as restaurants and the like) in the vicinity of the consumer's residence or workplace.

Moreover, the dated promotions may be provided in the form of text or verbal communications. For instance, a consumer desiring to receive dated promotions from retail outlets in a given location may telephone a designated telephone number operated by the server rather than establishing a connection with the server via the Internet. In response to receipt of such a call, the server operates an integrated voice response system to provide the consumer with the menu choices described above, but in the form of a synthesized voice rather than a text menu. The voice prompts issued by the server instruct the consumer to make selections by entering a number or series of numbers (or a phrase) into the telephone keypad or request the consumer to make selections by verbal response. During the process, the consumer is requested to enter a zip code or other geographically descriptive data. In response, dated promotions are given to the consumer by the synthesized voice generated by the server.

The most difficult challenge facing retailers, particularly those that do not have a national reach, is enticing consumers to visit a store. If a large enough number of consumers are drawn to a particular retail outlet, sales can be increased dramatically even if only a relatively small percentage of such consumers make purchasers.

The present inventors have realized the value of the inventive system for creating additional incentives to draw interested consumers to local retail outlets. In accordance with this aspect of the invention, the system described above issues emails notifying registered consumers of prizes available in one or more local retail outlets. Such email notifications are preferably time-sensitive and notify consumers that one or more consumers in their area have won a prize that may be claimed at a local retail outlet. The size and nature of the prize may be determined on an individual basis as specified by a particular retailer. The server randomly selects winners from a file of email addresses of registered consumers, and a corresponding notification is provided to the participating retailer by email, fax, telephone, regular mail, or the like.

### BRIEF DESCRIPTION OF THE DRAWINGS

FIG. 1 is a diagram of a computer network in which the data processing system and method of the present invention may be implemented;

FIG. 2 is a block diagram of a computer which is used in connection with the preferred embodiments of the present invention, and which may serve as a consumer data processing unit, a server, an issuer data processing unit and a redemption data processing unit; and

FIG. 3 is a flowchart diagram of a preferred embodiment of the present invention, which is a method for the targeted distribution of dated promotions over a network.

### DETALED DESCRIPTION OF THE PREFERRED EMBODIMENTS

The teachings of the present invention are applicable to many different types of networks, including computer networks, and may also be used, for instance, in conjunction with direct online connections to databases. As will be appreciated by those of ordinary skill in the art, while the following discussion sets forth various preferred implementations of the method and system of the present invention, these implementations are not intended to be restrictive of the appended claims, nor are they intended to imply that the claimed invention has limited applicability to one type of network or that the inventive system and method is limited to a computer network. In this regard, the teachings of the present invention are equally applicable for use in devices such as televisions (e.g., so-called interactive TV), telephones, cellular and satellite communications devices and the like, handheld computers, wristwatch-type computing devices, and any other type of data transmission and receiving device capable of achieving connectivity with a server. Accordingly, the present invention applies to any type of network, including local and wide area networks, private networks, on-line subscription services, on-line database services, public networks including the Internet and the World Wide Web, television networks, satellite networks, and wireless networks. While the principles underlying the Internet and the World Wide Web are described in some detail hereinbelow in connection with various aspects of the present invention, this discussion is provided for descriptive purposes only and is not intended to impart limiting aspects to the broadly claimed methods and systems of the present invention.

Although the present invention may be practiced using both public and private networks, public networks are particularly well suited for use in connection with the present invention. For this reason, implementation of the present invention will be discussed in detail in connection with the Internet and the World Wide Web. This discussion is equally applicable to any network whether based upon the client-server model or another model capable of achieving the functionality described herein. As will be readily appreciated, the term network is used broadly herein to identify a system of data processing devices which are selectively connectable to each other and is not limited to a computer network.

As will be further appreciated by those of ordinary skill in the art, as used herein, the term “client” refers not to a physical person or other entity, but to a client computer (or machine) on a network, or to a process, such as a Web browser, which runs on a client computer in order to facilitate network connectivity and communications. Thus, for example, a “client machine” can store and run one or more “client processes.” The terms “user” and “consumer” are used to broadly refer to one or more persons that use a particular client machine. As used herein, a “server” is a computer on a network which is used to serve information to a client on the same network.

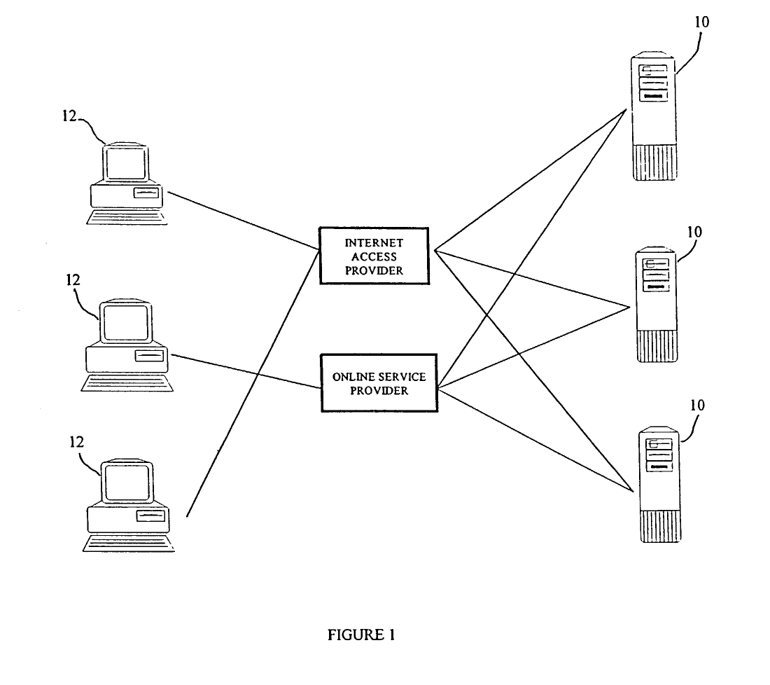

FIG. 1 illustrates a known computer network based on the client-server model, such as the Internet. The network comprises one or more servers 10 which are accessible by clients 12, such as personal computers, which, in the case of the Internet, is provided through a private Internet access provider (such as Digital Telemedia in New York City) or an on-line service provider (such as America On-Line, Prodigy, Compuserve, the Microsoft Network, and the like). Each of the clients 12 may run a “Web browser”, which is a known software tool used to access the Web via a connection obtained through an access provider. The servers allow access to various network resources. In the Internet, for example, a Web server 10 allows access to sc-called “Web sites” which comprise resources in various different formats. A location of a resource on a server is identified by a so-called Uniform Resource Locator, or URL.

The “World Wide Web” (“Web”) is that collection of servers on the Internet that utilize the Hypertext Transfer Protocol (HTTP). HTTP is a known application protocol that provides users access to resources (which can be information in different formats such as text, graphics, images, sound, video, Hypertext Markup Language (“HTML”), etc., as well as programs. HTML is a standard page description language which provides basic document formatting and allows the developer to specify “links” to other servers and files. Links are specified via a Uniform Resource Locator or “URL”. Upon specification of a link, the client makes a TCP/IP request to the server and receives information that was specified in that URL (for example, another Web page that was formatted according to HTML) in return. The information returned may be generated in whole or in part by a program that executes on the server. Such programs are typically known as CGI (Common-Gateway-Interface) scripts and can be written using known programming languages or methods that the server supports, such as PERL or C++. A typical Web page is an HTML document with text, links that a user may activate (e.g. “click on”), as well as embedded URLs pointing to resources (such as images, video or sound) that the client must fetch to fully render the Web Page in a browser. These resources may not be located on the same server that the HTML document was sent from. Furthermore, HTTP allows for the transmission of certain information from the client to a server. This information can be embedded within the URL, can be contained in the HTTP header fields, or can be posted directly to the server using known HTTP methods.

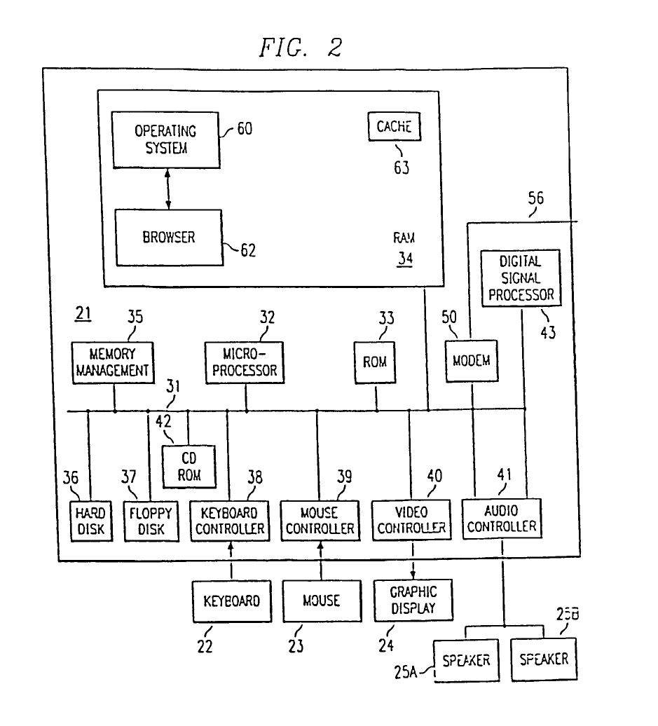

FIG. 2 is a block diagram of a representative client computer in the client-server network model. The same or similar computer can also be used for each of the servers. The system unit 21 includes a system bus 31 to which various components are coupled and by which communication between the various components is accomplished. The microprocessor 32 is connected to the system bus 31 and is supported by a read only memory (ROM) 33 and random access memory (RAM) 34. The ROM 33 contains, among other code, the basic input-output system (BIOS) which controls basic hardware operations such as the interaction and the disk drives and the keyboard. The RAM 34 is the main memory into which the operating system 60 and application programs, such as a Web browser 62, are loaded and cached 63. The memory management chip 35 is connected to the system bus 31 and controls direct memory access operations, including passing data between the RAM 34 and the hard disk drive 36 and the floppy disk drive 37. The CD ROM 42, also coupled to the system bus, 31, is used to store a large amount of data, e.g., multimedia programs or large databases.

Also connected to the system bus 31 are various I/O controllers: the keyboard controller 38, the mouse controller 39, the video controller 40, and the audio controller 41. The keyboard controller 38 provides the hardware interface for the keyboard 22, the controller 39 provides the hardware interface for the mouse (or other hand-operated input implement) 23, the video controller 40 provides the hardware interface for the display 24, and the audio controller 41 is the hardware interface for the multimedia speakers 25a and 25b. A modem 50 (or network card) enables communication over a network 56 to other computers over the computer network. The operating system 60 of the computer may be a Windows-based operating system, Macintosh Os, OS/2, AIX, BE 05, Linus, or any other known operating system capable of achieving the functionality set forth in the appended claims, and each client computer is sometimes referred to as a “client machine”, a client “computer”, or simply as a “client.”

As noted above, the Internet includes a public network using the Internet Protocol (TCP/IP) and includes servers 10 which are accessible by clients 12. When a Web browser 62 is used to access a file on a server 10, the server 10 may send information including graphics, instruction sets, sound and video files in addition to HTML documents (Web pages) to the requesting client.

Referring again to FIG. 1, a system for the generation and distribution of dated promotions according to the present invention may be implemented in a client-server network over the Internet. Client computers 12 operated by consumers (which will be referred to herein as “consumer data processing units”, a term which also encompasses any other type of data processing device capable of achieving the functionality recited in the appended claims) are selectively connectable to a server 10 via an Internet service provider or an online service provider. The server 10 may be any general purpose digital computer which is capable of serving as an Internet host, which may be a computer having the general structure described in connection with FIG. 2. The internal memory of the server is adequately large for storing, in addition to all of the necessary operating system components, data for identifying a plurality of participating retail outlets, including inventory data, name and geographic location. Also stored in the memory of the server is a database of available dated promotions. The data used for the generation of dated promotions will vary depending upon the promotion, but generally includes data representative of a combination of indicia and optionally graphics which communicates discount information, which, in the case of goods, may include product name, brand name, uniform product code, bar code image, expiration date, and optionally a graphical image of the goods or a logo. In the cases of services, some of this information may be omitted. The dated promotion also includes data concerning the amount of the savings, and the date(s) of the sale. In addition, the dated promotion may also contain a unique serial number and the PIN number of the consumer. Preferably, the dated promotions are transmitted to consumer data processing units as HTML email documents based on the dated promotion data so that they may be easily output from a hardcopy apparatus attached to the consumer data processing unit. The hardcopy apparatus may be a printer, in the case of printed coupons, or a known type of electronic device used for producing electronic credit information, such as a smartcard programmer.

In addition to the data associated with participating retail outlets and the coupon data, the server memory also contains a database of consumer identities, and, in addition, consumer profiles for storing monitored information about each consumer.

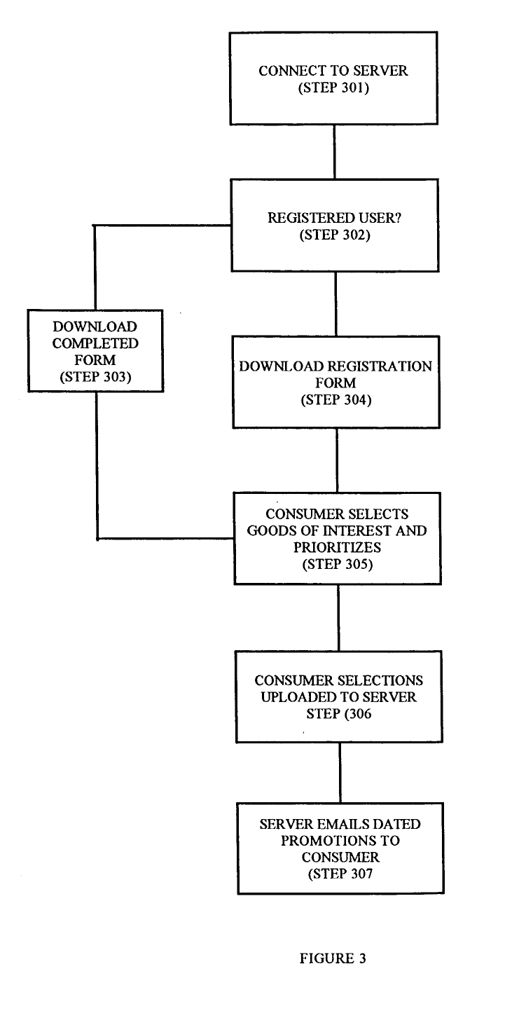

Referring to FIG. 3, a method for the targeted distribution of dated promotions according to the present invention is illustrated. Upon connection to the central server using a consumer data processing unit, which may be a client computer on the Internet, a television set (or set top box), a handheld computing device, or the like (step 301), the server executes a registration or initialization process in order to identify the consumer. First, the server executes an initialization process in which it determines whether the consumer unit is a registered user (Step 302). If the consumer is previously registered, the server downloads a previously filled-in form for modification by the user (Step 303). If the consumer has not previously registered, the server executes a registration process (Step 304) in which the server transmits a registration file in the form of an HTML formatted fill-in form for display on the consumer data processing unit requesting the consumer to register by entering demographic data such as name, address, phone number, email address, and the like, or any part of this information. The fill-in form also contains a list of goods and/or services, as shown in FIG. 4, along with information allowing the consumer to restrict the number of dated promotion emails to be received as described above. The server then assigns a unique PIN number to the consumer. If registration has already occurred during a previous session, the consumer's PIN number (or other registration criteria) is either entered by the consumer in response to an HTML fill-in form or automatically obtained from the consumer's computer unit if previously stored therein (which is preferable).

While registration may be desirable or necessary depending upon the particular application, it is not required to practice the invention. Instead of requiring consumers to enter demographic information during a registration process, the server may sufficiently identify users by use of network IDs or other identifying indicia (such as “Caller ID”, if used on a given network, or if this information becomes available over public networks such as the Internet), whereby the server acquires such indicia from the consumer data processing unit. If implemented over a public computer network, such as the Internet, for instance, user identification can be accomplished by means of acquiring the permanent or temporary user IDs used to route data communications over the network. If no IDs have been set or none can be obtained, the server may set a permanent ID file in the consumer data processing unit in a known manner. In this manner, consumer registration can be optional but consumers may be advised that registration entitles them to additional advantages, such as additional savings.

Moreover, all registration information may be provided by the consumer via a hardcopy registration form placed in convenient locations such as in print media, retail outlets, and the like, or such information may be provided by internet service providers or credit card issuers.

In an alternative embodiment, additional and optional steps are taken. After identification of the consumer or consumer data processing unit has been established, the server may optionally search its memory to determine whether the consumer has previously entered his or her birthday and/or anniversary data and selected one or more preferred retail outlets. If not, the server downloads a form requesting this information. The server then downloads a list of retail outlets in the geographic area of the consumer. In this optional process, the list of retail outlets is determined by searching the server's memory for retail outlet data for participating retail outlets within a predetermined distance from the consumer unit (or within a given postal zip code, telephone exchange, or other defined region). The user then makes a selection of preferred retail outlets from the displayed list. In this manner, the consumer may designate retail outlets (or service providers) from whom dated promotions would be of the most interest.

As an option, a file containing a list of all participating retail outlets, or all participating retail outlets in a geographic region selected by the consumer, may be downloaded for display on the consumer data processing unit, thus obviating the need for determination by the server of retail outlets within the geographic vicinity of the consumer.

After one or more single retail outlets have been selected in the alternative embodiment discussed above, a file of the goods and services offered at a discount by such retail outlets is downloaded to the client computer. This file is assembled based on a database located on the server which contains information pertaining to each participating retail outlet. In addition, the file may be arranged in any desired manner for display on the consumer data processing unit, such as in alphabetical order, by category of goods or services, by geographic location, and the like. This aspect of the alternative embodiment may be omitted.

In the first preferred embodiment, the consumer selects from the items of goods of the fill-in registration form by use of the user input device (in the case of a computer mouse, selection is made by “clicking” on the displayed goods) (Step 305). This process continues until the consumer has selected all desired goods and designated their priority in terms of identifying the maximum number of emails to be received pertaining to each type of goods selected.

In response to uploading of the consumer's submission of the selected goods or services (Step 306), the server searches its memory for available dated promotions or other promotional information pertaining to the selected goods or services and downloads such promotions by email to the consumer data processing unit (Step 307).

In the fill-in form, only the consumer's geographic area and email address are essential to enable the server to email dated promotions to the consumer. Other information may also be requested, if desired, such as budget, preferred user of goods, range of the consumer's age, interests, and the like, in order to enable the inventive system to make an educated determination of the nature of dated promotions to be transmitted via email to consumers and avoid the distribution of unwanted and unwelcome promotional emails. In the first embodiment described above, the user is presented with a list of selectable goods. The dated promotions are transmitted to the consumer via separate emails each preferably containing only a single dated promotion along with a header for display on the user's email facility identifying the nature of the sale, so that the consumer need not actually open the email to learn the specifics of the promotion. Importantly, the dated promotions are selected from those retailers and/or service providers located in the geographic vicinity (such as a comfortable walking or driving distance) of the residence of the consumer, which information is determined based on the consumer's residence address entered in the registration form. In another embodiment, the consumer contacts the server using a computing device (e.g., computer, cellular phone, or the like) and notifies the system of a zip code or other geographic indicator so that the consumer may receive dated promotions pertinent to that geographic area. This extends the consumer's ability to obtain promotions while traveling. The required information to be provided to the server can be determined based on zip code, telephone area code, telephone dialing exchange, or the like. During the registration process, consumers are preferably provided with a list of goods and services for which the consumer is interested in receiving dated promotions and other information as described hereinbelow, and are optionally asked to prioritize the importance of various goods and for any limit on the number of emails to be received in a given time period.

As noted above, dated promotions transmitted via email are preferably arranged so that each promotion offered by a retailer is given its own email transmission and heading so that the consumer may determine from the heading alone the identity of the nature of the dated promotion, such as the type of goods, the identity of the retailer offering the promotion, the date(s) of the dale and/or the amount of the savings.

By distributing dated promotions in the foregoing manner, such promotions are distributed to consumers who actually have an interest in the goods offered for sale, and provide for notice of special, highly time-sensitive sales of the type described above, or the like, during certain ranges of dates or on specific dates associated with substantial purchasing activity.

When implemented over the Internet, the various files downloaded to the consumer data processing unit may be in the form of HTML documents sent from the server to a consumer data processing unit based on a TCP/IP request. The HTML documents preferably originate from a central server on which coupon creation and distribution is achieved, in which case each HTML document may be obtained by the consumer data processing units (which are client computers in this embodiment) through a TCP/IP request to the server. In addition, one or more of the HTML documents for implementing the above-described embodiment may also be embedded in an executable program that executes on the consumer data processing unit and is stored, for example, in RAM during a period of connection between the server and consumer unit. In such case, one executable program could contain the initialization and registration routine, in which the user of the consumer data processing unit is asked to register with the coupon distribution service by entering various identifying information, such as name, mailing address, email address, and any pertinent demographic data. Such an executable program could also monitor data input by the user for predetermined actions such as keyboard events, mouse events, voice commands, and the like, in order to determine selections of goods and/or retail outlets made by the consumer. The executable program thus originates from the server and may be downloaded for use on a consumer data processing unit during each individual transaction, in which case the consumer data processing unit may “cache” a copy of the program in memory. Alternatively, the program could be permanently stored on the consumer data processing units. In such case, the program preferably contains instructions which enable the execution of certain steps before the consumer causes the consumer data processing unit to connect to the server. For instance, the program may be downloaded for permanent storage on a consumer data processing unit after certain initialization processes have taken place, such as user registration and identification of the geographical location of the client. The program can be downloaded along with a list of selected retail outlets and goods sold in those outlets. The program may then be executed by the consumer on the consumer data processing unit to make selections of retail outlets and associated goods and then connected to the server over the network to obtain the pertinent coupons. Irrespective of the manner in which the program is executed and stored, the basic operations, functions and transmission of information to the server is essentially the same. In all cases, the program executes on a client computer to provide the user with lists of retail outlets. The selection of one or more retail outlets causes the program to communicate with another process to obtain and display a list of selectable goods available in the designated retail outlets. Selection of goods by the consumer causes the program to communicate with the server to locate and download coupons for the selected goods and a customized shopping list. Either in addition to the available coupons, or, if no coupons are available for the brand of goods selected by the user, the consumer may be given the opportunity to receive coupons for a competing brand or for the same brand of goods sold by a different retail outlet.

The initialization or registration process program may also be implemented by use of the so-called “customizable home page” technique, which is a known process for obtaining information concerning client selections and preferences. A “customizable home page” permits users, upon the request of a server, to make certain choices from a list of items downloaded from a server and displayed on the client computer. When a user who has made such choices contacts the same server at a later date, the server assembles information for downloading to the user in accordance with the previously-selected choices. More specifically, the user visits a so-called “Web page” of the coupons server where he or she is asked to fill in a blank form or select various choices from a list of alternatives, which, in this case, may be geographically locations or a list of retail outlets. The user then submits this information to the server by clicking the so-called “submit” button of the fill-in form, which causes the client computer to transmit the information to the server. The server returns a Web page with a response header which creates, or “sets” an ID field located in a file on the client computer (this file is known as the “client ID” or “cookie”) to include information pertaining to the user's selections. When the user later returns to a specified Uniform Resource Locator, or “URL”, on the same server, the “client ID” or “cookie” with the previously-set preference information is transmitted in the HTTP request header to the server, which can then return a Web page that is assembled according to the user-specific information. This application is disclosed, for example, in A. Gundavaram, CGI Programming on the World Wide Web, O'Reilly Press, 1996, the teachings of which are incorporated herein by reference.

In the foregoing manner, the server is able to determine the identity of a particular consumer. Thus, when a registered consumer connects to the server via computer, the server detects the identifying indicia from the response header provided to the server, including any data identifying preferred retail outlets.

After initialization is completed, the server downloads a list of participating retail outlets in the general locale of the client computer. Alternatively, the list of participating retail outlets may be selected based on data supplied by the user during the initialization process, such as the consumer's residence or business address. As noted above, when the consumer accesses the server after the first use, during which registration is performed, the list of retail outlets is downloaded and displayed. This is achieved by a process similar to the customizable home page.

A variation of the “customizable home page” technique is used by some servers to download forms which are designed as executable programs. For instance, one such application disclosed by G. Cornell and C. S. Horstmann, in Core Java, The SunSoft Press, 1996, which is incorporated herein by reference, involves the generation of an “order form” on client computers by a program downloaded to the client computer. In this application, the client machine loads a Web page from a server which has an embedded link to an executable program that downloads to and executes on the client machine. Upon execution in the client machine, the program contacts the server and retrieves, for instance, a list of goods and associated prices. The program allows the user to order various goods and-requires the user to fill out a form for billing purposes. The user “clicks” on the submit button of the fill-in form to transmit the information to the server.

In a simplified embodiment, the consumer is provided merely with a template which provides a region to fill a list of selected goods (i.e., a shopping list) in by typing or other means of data entry, or, which provides a list of retail outlets and associated goods, and means for selecting respective retail outlets or goods by use of a selected keyboard code, mouse click, or operation of another type of input device. Whether the invention is implemented by the use of forms such as HTML document documents or as an executable program which downloads and runs on the consumer data processing unit, or by the use of a template which permits entry of a list of goods, and which may be permanently stored or cached on the consumer data processing unit, is of little consequence in terms of the basic functionality of the inventive system and method. In all of the preferred embodiments, the consumer is prompted to select goods offered for sale in a particular retail outlet, or type of retail outlet, and the server downloads coupons corresponding to the selected goods.

As will be appreciated by those of ordinary skill in the art, security restrictions may, in some cases, prevent one from having direct access to information stored on a client's hard disk, such as client IDs (so-called “cookies”). In such cases, other means may be used to obtain this information. For example, when a Web browser makes a request for information from a server it typically includes certain information about the client in the “HTTP request header.” The server receiving the request can obtain and store this information using known means implemented, for example, in a so-called “CGI script” executable on the server. Therefore, one way of obtaining consumer identifying indicia is to embed a request in the HTML file for another resource on a server that will obtain and store the consumer identifying indicia. This resource may be a program (such as a CGI script) that captures relevant information and stores it. This information can then be combined with information monitored based on consumer selections, such as coupons downloaded, coupons redeemed, which can be used in combination with consumer identifying indicia to provide a more detailed knowledge base. This embedded request may be in addition to the embedded tracking program. Representative CGI scripts capable of capturing client identifying indicia are disclosed by A. Gundavaram, in CGI Programming on the World Wide Web, O'Reilly Press, 1996, which is incorporated herein by reference.

In order to store consumer identifying indicia for registered and non-registered consumers, such as consumer identity, address, consumers' network ID (IP) and client ID numbers (cookies) and associated consumer information (such as locale), one or more databases are set up on either the server or another location (such as the coupon issuers). This may be done in any known manner, such as by using a commercially-available database program designed, for example, for the high-speed processing of large databases. In the case of the program described above, the information stored in the database may include any of the personal demographic data entered by the user upon registration with the coupon distribution service. However, user registration is not a necessary element in an implementation of the coupon distribution service, and client identifying indicia such as network ID and client ID can nonetheless be obtained so that coupon issuers and other advertisers can obtain useful demographic data regarding consumer purchasing habits.

A database containing the consumer identifying data, network ID, client ID, selected retail outlets, selected goods along with other pertinent choices made by the consumer (such as coupons downloaded, coupons redeemed, timing and quantity of purchases) is maintained on the same server from which the Web page originates, or on a different server. Thus, the above-described method permits participating producers and retailers to determine not only the number of coupon redemptions obtained, as in the prior art, but also permits the accurate determination of the purchasing needs, habits, and desires of individual (but possibly anonymous) consumers. This is invaluable information to manufacturers and of vendors of goods and services, among others, and permits such entities to make informed decisions as to the effectiveness and value of particular promotional campaigns, as well as the demand for particular products.

For instance, the Web pages (or HTML document) associated with the coupon distribution service is requested by a client computer from the server, using TCP/IP and HTTP protocols. This HTML document contains text, as well as embedded URLs that point to graphical images (e.g., GIF format image files) also located on the server. The images, in general, may be located on any HTTP server on the Internet, and are used to produce a graphical display on the consumer data processing unit identifying the coupon distribution service, and to display pertinent instructions, and fill-in forms associated with user registration (if required). The images are embedded inside the Web page using the known HTML <IMG> tag, which allows one to specify the source URL for an image, as well as additional information such as size and other layout parameters. These images are fetched by the consumer data processing unit using TCP/IP and HTTP protocols from the server and rendered on the Web browser.

As pointed out above, where user registration is not required, consumer identifying data may be obtained in an alternate manner. For instance, a Web page associated with the coupon distribution service would include additional information which is used to obtain client identifying indicia. This may be accomplished as follows. A URL is preferably used to point to a non-graphic resource that resides on the server or a different server, that resource comprising an executable program, which executes on the server, and is a CGI script. In attempting to render the Web page, the consumer data processing unit will automatically fetch this resource, which forces execution of the CGI script on the server and the return of information output from the script to the consumer data processing unit. When the CGI script executes, it may collect information from the HTTP request header such as browser type, network ID (IP address), and if set, client ID (“cookie”), as well as any additional available information such as time of execution and the URL of the Web page, and store it in a database—for example using SQL. The CGI script returns information to the consumer data processing unit, which includes a response header which indicates (among other information), that the return type is an image, that this resource should not be cached by the consumer data processing unit, and if no client ID is set and the client supports it, that a client ID is to be set to a value generated by the script.

The CGI script may also monitor the number of times the Web page has been accessed in general. On the other hand, another CGI script located on the same or another server may be used for this purpose. This process may be carried out by simply incrementing a counter each time the resource is accessed, or may be conducted at any other time by merely counting the number of entries made in a stored record of requests made for the resource. Separate counters may also be maintained for individual consumer data processing units that have contacted the server.

Much like the transparent acquisition of IDs, the present invention also provides for the transparent monitoring of consumer use of the coupon distribution system to monitor coupon access, shopping preferences, timing and quantity of purchases, and like information. In order to do this, a second resource is located on the server, and constitutes a JAVA applet. This resource can also be located on any other server, and is embedded in a Web page using the known HTML <APPLET> tag, which allows one to specify the source URL (through the CODE and CODEBASE parameters) as well as additional size, layout and initialization parameters. The consumer data processing unit, in attempting to render the Web page, will automatically fetch the applet by making a request to the server using the TCP/IP and HTTP protocols. After it has received the JAVA code for the program, the program will remain resident on the consumer data processing unit memory while the consumer forms a shopping list by making one or more selections of retail outlets and goods, in the manner described above. The executable program monitors all selections made by the consumer and uploads this information to a consumer profile database. As noted above, the program can also be executed in a variety of ways, and need not be a program that runs on the consumer data processing unit.

User selections of retail outlets and goods can be sent using standard JAVA network methods, such as opening a URL connection to a second CGI script on the server (or any other server) designed to capture this information. This second CGI script can then obtain any information transmitted by the applet as well as any available information in the HTTP request header. This information can be stored in a database on the same or a different server. If necessary, the information stored by both scripts may be combined into one or more complete databases. As will be understood by those of ordinary skill in the art, acquisition of information by the server need not be conducted using CGI scripts. For instance, this information may be acquired by any other server-resident process designed for this purpose, or may be uploaded by the executable program or other client-resident process, such as by a direct connection to a resource located on a server (i.e., a database), or by using any other known process.

The database thus constructed can be indexed by any one of a multitude of identifiers, such as any element of consumer identifying indicia, or any element of selected information, such as preferred retail outlets, preferred brands, type of goods, category of goods, geographic locale, retail outlet, type of retail outlet, consumer identity, and the like, and may contain information about registered or unregistered users who have visited the Web page of the coupon distribution service, such as their network and client IDs, how often they visited the Web page, whether they obtained coupons, whether any coupons (and which coupons) were redeemed, and the like. Analysis of the data on a user-indexed basis would facilitate the determination of individual user interests and purchasing habits. On the other hand, analysis of the data on a brand name, goods or retailer-indexed basis would allow the determination of, for example, the demand for certain brands and products, and the popularity of certain retail outlets.

The demographic information obtained based on user interaction with the coupon clearinghouse Web page may be used not only to determine the effectiveness of products and marketing campaigns, but “historical” user profiles based upon consumer purchasing habits and desires may be constructed to target the service of promotional information (such as ad banners), to construct personalized Web pages containing targeted promotional information to users, to serve targeted purchase incentives for one brand of product to attract customers of another brand (as identified by the consumer profile) or to offer price incentives to loyal customers. The information on consumer purchasing habits may also be used to assemble resources geared toward the consumer's interests. Based upon the historic consumer profiles created in the server database, downloading of information to the same consumer data processing unit on a subsequent visit to the server may be done on a more intelligent basis. For example, consumers who have previously expressed an interest in sports-related information (as indicated by their previously purchasing history) may be served with information targeted to audiences interested in sports. Similarly, consumers who have expressed greater interest in electronics-related goods may be served with technology-related information that would be of much less interest to other users. The assembly of a resource such as a Web page may be easily accomplished. For example, the HTML document of the Web page may include a plurality of embedded resources. Previous choices made by a consumer on a particular client data processing unit and stored in a consumer profile database may be used to determine which of the resources is to be downloaded to that consumer using simple logical processing instructions. For instance, a consumer profile which indicates that a user has a greater interest in sports-related information than in historical information may be used to assemble a resource having information geared towards sports-related resources, such as GIF-type images and advertisements. Since the consumer has previously expressed a greater interest in sports, sports-related advertisements may therefore be targeted to that user. If the user has purchased an item of sporting goods from one source, a coupon from that (or a competitive source) can be provided. In a similar manner, price competition can be fostered to an even greater extent by forcing competitors to fight for individual consumers, thus benefitting the individual consumer.

The executable program downloaded to the consumer data processing unit in one embodiment of the invention comprises a tracking program for monitoring keyboard events, voice commands, mouse clicks, as described above. However, the executable program may also monitor the consumer's selection of retail outlets and goods. Upon submission of the selected goods to the server, a server resident process searches for coupons for goods selected by the consumer which, as described above, may be dependent upon the selected retail outlet. The server resident process then downloads to the consumer data processing unit all coupons uncovered by the search. In addition, the serve may optionally download information including a tabulation of total suggested retail price and total cost savings provided by the coupons as well as the information discussed above. Additional information for downloading to registered consumers would include advertisements or purchase incentives offered by local merchants. The intended recipients of these coupons can be determined with reference to the selected retail outlet (or consumer identifying data).

In accordance with another aspect of the invention, the consumer is given the opportunity to limit or restrict the number of promotions received via email or similar facility. In accordance with this aspect of the invention, during a period of connection with the server over the communications medium, the server downloads a file to the consumer unit which displays on the consumer unit one or more options for restricting or limiting the number of dated promotions to be transmitted to the consumer unit over a given period of time. These options may include any one or more options, such as allowing the consumer to limit the maximum number of dated promotions received during a given time period (e.g., one day, week or month), or to limit the number of dated promotions transmitted in another way, such as by allowing the consumer to prioritize the dated promotions to be received. This may be accomplished by allowing the consumer to limit the received promotions to one or more specific days such as one or more holidays, birthdays, anniversaries, or the like, or to limit the dated promotions to specific types of promotions (e.g., holiday sales, one-day sales, private sales, 50% or more sales). Other ways such promotions may be limited is by allowing the consumer to prioritize dated promotions by type of goods, intended user or consumer (children, women, men, etc.), or level of retail outlet (e.g., upper tier, middle tier, lower tier). Yet another way consumers may limit the number of promotions received is by restricting the receipt of dated promotions to those offered by retailers within a specific town, village, or geographic distance from the consumer's home.

Furthermore, any one or more of the foregoing means of limiting the number of may be used alone or in combination. For instance, by allowing the consumer to restrict the maximum number of dated promotions to be received in a given time period and to prioritize among the various dated promotions in terms of importance of goods on a given scale (or other prioritizing scheme discussed above), the number of dated promotions that will be received by the consumer will be limited to those which are of the greatest significance to the consumer and hence the most likely to be utilized, thereby enhancing the value of the inventive system and method.

The methods embodied in the invention may be used to create web resources with so-called “persistent” state. That is, the selection of goods from the shopping list downloaded from the consumer, in addition to the client profile database, may be part of a Web resource that appears to automatically “remember” the consumer's previous interactions on the Web resource. Thus, for instance, the shopping list can be implemented as a Web page with a list of goods for selection by the consumer, as described above. When the page is rendered and the shopping list is being selected, a consumer is able to use the keyboard and mouse to select goods' from the displayed list. At the same time, these choices are monitored, along with consumer identifying indicia. Before or at the time the consumer leaves the Web page, the current selections are sent to the server for storage, along with the consumer identifying indicia. When the consumer later returns to that page, the user ID (for registered users) or the network or client ID (for unregistered users) is used to automatically highlight or fill in the previous selections.

Although the invention has been described in terms of preferred embodiments, those skilled in the art will recognize that various modifications of the invention can be practiced within the spirit and scope of the appended claims. Thus, for example, the scripts used to transfer data need not be CGI scripts but could be a dedicated server or a direct connection to the database, such as using JDBC (Java Database Connectivity) to place data into the database.

In addition, while the above embodiment has been described in connection with a JAVA applet that is executable on a consumer data processing unit, the executable program may be accomplished by a program written in a language other than JAVA. For example, the teachings of the present invention may be accomplished using Active-X components in conjunction with the Internet Explorer Web browser. In addition, the program need not be a program that executes on the client computer, and may comprise a CGI script located on a server. The Web browser can be used to send a signal to the server that downloaded the Web page upon the occurrence of a predetermined user operation (such as exiting the Web page or clicking on a link to another Web page or resource). In this manner, a program running on the server can be used to determine the information selected by the consumer.

It should also be appreciated that while the preferred embodiments of the disclosed invention use a single database to store the information, multiple databases could be used to store and process the information.

In addition, while in the preferred embodiments of the invention the server that originated the tracking program and the database reside on the same machine, this is not a requirement of the present invention. The database may instead reside on a separate machine from that which serves the shopping list program. Similarly, while in the preferred embodiments the same server originates all network resources, including any Web pages, HTML fill-in forms, and the executable program, this is not a requirement of the present invention. The network resources and executable program may be served out by the same server. The shopping list program may actually be “served” by any hardware on the network, including the hard drive of the client computer. It should also be appreciated that while in the preferred embodiments the HTTP and TCP/IP protocols are used, other network data transmission protocols could be used that implement the same functionality. Moreover, use of an HTML formatted Web page is not necessary. The files transmitted to the consumer data processing unit may not be in the form of an HTML or Web document such as a Web page, but can be some other form of information. In addition, the executable program together with the files used for displaying and selecting retail outlet and goods need not be downloaded to the consumer data processing unit from the server, but can be an added module to a consumer data processing unit application or Web browser running on the consumer unit, or may be stored elsewhere on the consumer data processing unit. For example, in the former case, added modules could be plug-ins and in the latter case could be referred to as cached resources. In such cases, the client application or Web browser would include appropriate means to enable activation of the executable list program and the uploading of a consumer profile based upon the user's selections on the shopping list.

Moreover, although in the preferred embodiments it is envisioned that the network resource or Web page is downloaded from a remote server, this is not a limitation of the invention. The precise location of the target document or server is not important. For example, the target document may even be located on the hard drive of the consumer data processing unit.

Also, while in the above-described embodiments, the consumer profile may be created automatically using information acquired by the shopping list program and one or more CGI scripts and is stored in the server database, the consumer profile can be created in a different manner and/or supplemented by additional information. For example, one such technique for creating a consumer profile is through the use of HTML “fill-in” form tags. In such cases, the consumer profile is created not by the shopping list program or by a fill-in form, but instead by the consumer. Based on the consumer profile, the server can serve out information targeted to the consumer's interest, as revealed by the fill-in form.

Also, while the preferred embodiments have been described in the context of Web browser software, the techniques of the invention apply equally whether the user accesses a local area network, a wide area network, a public network, a private network, the Internet, the World Wide Web, or the like, and whether access to the network is achieved using a direct connection or an indirect connection. For example, in connection with the World Wide Web, the teachings of the present invention apply whether a network connection is obtained via a direct Internet connection or indirectly through some on-line service provider. Thus, the “computer network” in which the invention is implemented should be broadly construed to include any network in which one or more consumer data processing units is connectable to one or more servers, including those networks based upon the client-server model in which a client can link to a “remote” resource (even if that resource is available on the same machine, system, or “Intranet”). The “computer network” need not be formed of PCs or other devices capable of performing data processing. The inventive method and system contemplates implementation on any type of handheld devices, wristwatch-type computing devices, cellular or satellite communications devices, computers, televisions, telephones, and the like.

It should also be appreciated that while in the preferred embodiments the executable program and HTML documents are downloaded from the server, this is not a limitation of the invention. These resources need not be embedded within an existing Web page, but rather may be embedded within a Web browser or supported elsewhere within the consumer data processing unit itself. In this manner, a “shopping list” program stored on the consumer data processing unit may be initiated by the consumer's call to the server resource (Web page) is made by means of a URL corresponding to the coupon distribution service. Alternatively, the program may be stored permanently on the consumer data processing unit and used to create a shopping list which is selectively transmitted to an online resource to obtain coupons based upon selected goods.

The data processing system of the present invention further comprises an electronic redemption center such as a data processing unit of the type illustrated in FIG. 2 that is located in a participating retail outlet, for tracking coupon use by recording all coupon transactions to a notification center, which may be the server or a data processing unit located at a respective coupon issuer, so that the validity of a coupon will be verified at the time of actual purchase and data pertaining to coupon transactions will be transmitted to the server for marketing purposes. Validation of coupons can be easily facilitated by use of a coupon identifying number that is entered into a retail outlet data processing unit that is connected to the remote server (or promotional information data processing unit), and which determines by conventional means whether the coupon is valid. Also at that time, coupon redemption is noted (for validation and marketing purposes) by deducting one from the number of available coupons of the redeemed type, and by making an entry in the redeeming consumer's profile to build a historic consumer profile.

Coupon issuers may also operate coupon issuer data processing units which are connectable to the server to upload coupon generating instructions to the server to generate electronic coupons. The coupon issuer data processing units are also similar to the computer illustrated in FIG. 2 and may also obtain reports based upon the access and redemption of coupons, consumer purchasing habits and demographics, and may additionally instruct the server to target the distribution of information to consumers based upon one or more conditions (such as the consumer's selection and redemption of certain coupons). The general structure and function of the coupon issuer data processing units and the retail outlet data processing units is disclosed in various of the above-identified U.S. patents.

In another embodiment, the inventive system is used to create additional incentives to draw interested consumers to local retail outlets. In accordance with this aspect of the invention, the system described above issues emails notifying registered consumers of prizes available in one or more local retail outlets. Such email notifications are preferably time-sensitive and notify consumers that one or more consumers in their area have won a prize that may be claimed at a local retail outlet. The size and nature of the prize may be determined on an individual basis as specified by a particular retailer. The server randomly selects winners from a file of email addresses of registered consumers, and a corresponding notification is provided to the participating retailer by email, fax, telephone, regular mail, or the like.

We claim:

1. A system for the electronic distribution of dated promotions, comprising:
a plurality of consumer computers each operated by a consumer and having a web browser for establishing connectivity with a remote server and an email facility for receiving email communications from the server; and
a server computer located remotely from the consumer computers and having a web browser for establishing connectivity with the consumer computers and for transmitting dated promotions in the form of email communications to the consumer computers, and being responsive to a connection with a consumer computer to transmit to the consumer computer a registration file for display on the consumer computer a fill-in form containing a demographic questionnaire requesting entry of at least a consumer's residence and email addresses, and containing a list of individually-selectable goods, and one or more options for permitting the consumer to prioritize in order of importance among selected goods or to limit or restrict the number of dated promotions to be received by the consumer by email from the server computer during a given time period;
wherein in response to receipt of the information entered in the fill-in form in the registration file, the server computer transmits to the consumer computers at the email addresses specified in the fill-in forms email communications containing dated promotions notifying the consumer of sales offered by retailers in the geographic area of the consumers' residence address, each dated promotion being contained in a separate email transmission containing a header viewable by the consumer without opening the email transmission, the header containing information including the identity of the retailer offering the dated promotion, a range of dates and identity of goods or services to which the dated promotion applies, and the nature of savings offered by the dated promotion.

2. A system for the electronic distribution of dated promotions according to claim 1; wherein the dated promotions comprise sales notifications for participating retail outlets in the geographic vicinity of the consumers' residence address, including one or more of notifications of time-sensitive offers restricted to registered consumers including one-, two- or three-day sales, sales on one or more holidays, and special events, which are intended to notify consumers of an upcoming sales event of the type made known to preferred consumers.

3. A system according to claim 1; wherein the consumer computers and the server computer communicate over a public telephone network; and further comprising means for acquiring identifying indicia through Caller ID data to identify the geographical location of the consumer unit.

4. A system according to claim 1; further comprising a printer for producing a printout of dated promotions transmitted to the consumer computer.

5. A system according to claim 1; further comprising a point-of-sale unit located in a participating retail outlet and comprising a display monitor, a memory for storing data to be displayed on the display monitor, a data processing unit connected to the display monitor and the memory and having communication means connectable over a communication medium to the server computer, a user input device to permit a consumer to make one or more selections from choices displayed on the display monitor, and a hardcopy apparatus for producing a hardcopy of sales notifications.

6. A system according to claim 5; wherein the server computer is located remotely from the point-of-sale unit, and further comprises means for transmitting to the point-of-sale unit a file containing the identity of goods offered for sale by the retail outlet at which the point-of-sale unit is located, the goods being individually selectable by the consumer using the input device; and the server computer further comprises means responsive to the selection of one or more items of goods by the consumer to transmit a third file for display on the display monitor of the point-of-sale unit containing second data corresponding to the selected goods, the third file containing dated promotions corresponding to one or more of the selected goods.

7. A system according to claim 1; wherein the consumer computers comprise client computers on a network.

8. A system according to claim 1; wherein the server computer comprises an Internet host computer.
